(19) United States
(12) Patent Application Publication
(10) Pub. No.: US 2006/0058488 A1
(43) Pub. Date: Mar. 16, 2006

(54) Functionalized polyherdral oligomeric silicon-oxygen clusters as cross-linking agents

(76) Inventors: Adolf Kuhnle, Marl (DE); Carsten Jost, Marl (DE); Hendrikus Cornelis Louis Abbenhuis, Nuenen (NL)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/511,593

(22) PCT Filed: May 2, 2003
(86) PCT No.: PCT/EP03/04587

§ 371 Date: Jun. 21, 2005

(30) Foreign Application Priority Data
May 8, 2002 (DE) 102 20 853.0

(51) Int. Cl. C08G 77/04

(52) U.S. Cl. 528/37

(57) ABSTRACT

The invention relates to a crosslinker for crosslinking matrix materials, to the matrix resulting therefrom, to the method employed therefor, and to the use of said crosslinker, the crosslinker comprising functionalized polyhedral oligomeric silicon-oxygen cluster units of the formula
[(RₐX_{b}SiO_{1.5})ₘ(R_{c}X_{d}SiO)ₙ(RₑX_{f}Si₂O_{2.5})ₒ(R_{g}XₕSi₂O₂)ₚ
with a,b,c=0-1; d=1-2; e,f,g=0-3; h=1-4; m+n+o+p≧4; a+b=1; c+d=2; e+f=3 and g+h=4; R=hydrogen atom, alkyl, cycloalkyl, alkenyl, cyclo-alkenyl, alkynyl, cycloalkynyl, aryl, heteroaryl group or polymer unit, which are in each case substituted or unsubstituted or further functionalized polyhedral oligomeric silicon-oxygen cluster units, which are attached by way of a polymer unit or a bridging unit, X=oxy, hydroxyl, alkoxy, carboxyl, silyl, alkyl-silyl, alkoxysilyl, siloxy, alkylsiloxy, alkoxy-siloxy, silylalkyl, alkoxysilylalkyl, alkylsilyl-alkyl, halogen, epoxy, ester, fluoroalkyl, isocyanate, blocked isocyanate, acrylate, methacrylate, nitrile, amino, phosphine group or substituents of the type R containing at least one such group of the type X, the substituents of the type R being identical or different and the substituents of the type X being identical or different.

The invention relates to a crosslinker for crosslinking organic and/or inorganic matrix materials, to the matrix resulting therefrom, to the process employed therefor, and to the use of said crosslinker, the crosslinker comprising functionalized polyhedral oligomeric silicon-oxygen cluster units.

Crosslinkers are very important for producing materials based on plastics. For producing inorganic materials, as well, crosslinking agents are essential for optimizing the properties.

In the case of organic matrix materials, curing takes place either by cooling after processing, such as with the thermoplastics, for example, or by subsequent crosslinking, such as with elastomers or thermosets, for example. This crosslinking can be carried out in a variety of ways. In many cases it is effected by exposing the matrix material to high-energy radiation. Another method is to produce free-radical compounds, which initiate crosslinking by way of double bonds in the polymer, for example. Crosslinking may likewise take place by the addition of crosslinkers having reactive groups, such as amino, hydroxy, isocyanate or epoxy groups, for example.

A crosslinker may act in two different ways. In the case of apolar matrix materials, which have no functional groups for covalent attachment of the crosslinker to the matrix material, the crosslinker reacts with itself to form an independent network in the matrix, this network being composed of the resultant structural units of the crosslinker. Such a network is referred to as an “interpenetrating” network. A further type of crosslinking, in many cases the preferred method, is the attachment of the crosslinker to the matrix material by way of covalent bonds. The reactive functional groups in the crosslinker and in the matrix material to be crosslinked must be matched to one another. For instance, both the matrix material and the crosslinker may contain double bonds, hydroxyl groups, carboxyl groups, amino groups, isocyanate groups or epoxy groups. The reaction between matrix and crosslinker is initiated by radiation, temperature, addition of moisture or addition of an initiator, so that covalent bonds are formed. Radiation used to initiate the process of crosslinking may comprise electron beams, UV radiation or microwaves. Where the matrix materials contain no functional groups, such as plastics based on polyolefins, for example, then functional groups can be generated subsequently. After a process of this kind, such as flame treatment or corona discharge, for example, hydroxyl and/or carboxyl groups are formed on the surface of a plastic and can be utilized for a reaction with the crosslinker.

For the formation of these covalent bonds there are a variety of appropriate chemical reactions and reaction mechanisms, such as
esterification (hydroxyl group plus carboxylic acid or carboxylic acid derivative group),
hydrosilylation (addition of an SiH group onto alkanes or alkenes),
urethane formation (hydroxyl group plus isocyanate group),
urea formation (amino group plus isocyanate group),
amino alcohol formation (epoxy group plus amino group) or
formation of hydroxy ethers (epoxy group plus alcohol).

Elastomeric, thermoplastic, and thermoset plastics have a high elasticity. Generally, however, they have a low temperature stability and a low mechanical stability. The surfaces of organic matrix materials, such as plastics, are generally less resistant to abrasion and scratching than the surfaces of inorganic matrix materials.

Inorganic matrix materials may be cured by water, as in the case of concrete, or by atmospheric carbon dioxide, such as in the case of mortar. In contrast to materials comprising organic matrices, materials comprising inorganic matrices possess a high mechanical strength and a high temperature stability. However, being highly brittle, inorganic materials have a low elasticity. Furthermore, a controlled and, where appropriate, rapid setting behavior is frequently required, as are hydrophobic properties in many cases.

It was therefore an object of the present invention to develop a crosslinker which raises the elasticity of inorganic matrices, such as concrete, mortar or plaster, for example, before they set and does not adversely affect the adhesion or cohesion of organic matrices, e.g., hotmelt adhesives, before they cure, but instead shortens their setting time and raises the mechanical stability or strength and the temperature stability.

Surprisingly it has been found that where crosslinkers containing functionalized polyhedral oligomeric silicon-oxygen cluster units are used in organic matrix materials the mechanical and thermal stability of the resultant material can be increased significantly. Furthermore, the use of crosslinkers comprising functionalized polyhedral oligomeric silicon-oxygen cluster units raises the mechanical strength of the resultant organic material. The use of these crosslinkers of the invention in powder coating materials based on isocyanates increases their adhesion, and the pot life of casting compositions based on epoxy resin is prolonged by virtue of their use. Although the various types of crosslinking and also the preparation of the polyhedral oligomeric silicon-oxygen clusters have already been known for a long time, it has not been recognized that these crosslinkers comprising functionalized polyhedral oligomeric silicon-oxygen cluster units in organic matrix materials are of essential importance for optimizing the properties of materials. The solution to the problem was all the more surprising since it was found that these crosslinkers comprising functionalized polyhedral oligomeric silicon-oxygen cluster units likewise exhibit a crosslinking effect with inorganic matrix materials. The consequence of this is that the elasticity of these inorganic materials produced in this way can be increased with the addition of chemical compounds comprising functionalized polyhedral oligomeric silicon-oxygen cluster units as a crosslinking agent.

By a polyhedral oligomeric silicon-oxygen cluster is meant, preferably, the two classes of compound represented by the silasesquioxanes and the spherosilicates.

Silasesquioxanes are oligomeric or polymeric substances whose fully condensed representatives possess the general formula (SiO_{3/2}R)ₙ, in which n≧4 and the radical R can be a hydrogen atom but is usually an organic radical. The smallest structure of a silasesquioxane is the tetrahedron. Voronkov and Lavrent'yev (Top. Curr. Chem. 102 (1982), 199-236) describe a synthesis of fully condensed and incompletely condensed oligomeric silasesquioxanes by hydrolytic condensation of trifunctional RSiY₃ precursors, where R stands for a hydrocarbon radical and Y is a hydrolyzable group, such as chloride, alkoxide or siloxide. Lichtenhan et al. describe the base-catalyzed preparation of oligomeric silases-quioxanes (WO 01/10871). Silasesquioxanes of the formula R₈Si₈O₁₂ (with identical or different hydrocarbon radicals R) can be reacted under base catalysis to functionalized, incompletely condensed silasesquioxanes, such as R₇Si₇O₉(OH)₃, for example, or else R₈Si₈O₁₁(OH)₂ and R₈Si₈O₁₀(OH)₄ (Chem. Commun. (1999), 2309-10; Polym. Mater. Sci. Eng. 82 (2000), 301-2; WO 01/10871) and thus can serve as parent compound for a host of different incompletely condensed and functionalized silasesquioxanes. The silases-quioxanes (trisilanols) of the formula R₇Si₇O₉(OH)₃ in particular can be converted into correspondingly modified oligomeric silasesquioxanes by reaction with functionalized monomeric silanes (corner capping).

Oligomeric spherosilicates have a construction similar to that of the oligomeric silasesquioxanes. They too possess a “cagelike” structure. Unlike the silasesquioxanes, owing to the method by which they are prepared, the silicon atoms at the corners of a spherosilicate are connected to a further oxygen atom, which in turn is further substituted. Oligomeric spherosilicates can be prepared by silylating suitable silicate precursors (D. Hoebbel, W. Wieker, Z. Anorg. Allg. Chem. 384 (1971), 43-52; P. A. Agaskar, Colloids Surf. 63 (1992), 131-8; P. G. Harrison, R. Kannengiesser, C. J. Hall, J. Main Group Met. Chem. 20 (1997), 137-141; R. Weidner, Zeller, B. Deubzer, V. Frey, Ger. Offen. (1990), DE 38 37 397). For example, the spherosilicate with the structure 2 can be synthesized from the silicate precursor of the structure 1, which in turn is obtainable by the reaction of Si(OEt)₄ with choline silicate or by the reaction of waste products from the harvesting of rice with tetramethylammonium hydroxide (R. M. Laine, I. Hasegawa, C. Brick, J. Kampf, Abstracts of Papers, 222^{nd} ACS National Meeting, Chicago, Ill., United States, Aug. 26-30, 2001, MTLS-018).

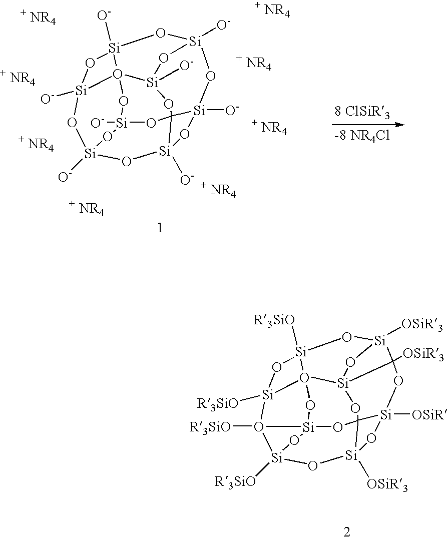

Both the silasesquioxanes and the spherosilicates are firmly stable at temperatures of up to several hundred degrees Celsius.

The present invention accordingly provides a crosslinker as claimed in claim 1 for crosslinking matrix materials, the crosslinker comprising functionalized polyhedral oligomeric silicon-oxygen cluster units of the formula
[(RₐX_{b}SiO_{1.5})ₘ(R_{c}X_{d}SiO)ₙ(RₑX_{f}Si₂O_{2.5})ₒ(R_{g}XₕSi₂O₂)ₚ]
with a,b,c=0-1; d=1-2; e,f,g=0-3; h=1-4; m+n+o+p≧4; a+b=1, c+d=2; e+f=3 and g+h=4;
R=hydrogen atom, alkyl, cycloalkyl, alkenyl, cyclo-alkenyl, alkynyl, cycloalkynyl, aryl, heteroaryl group or polymer unit, which are in each case substituted or unsubstituted or further functionalized polyhedral oligomeric silicon-oxygen cluster units, which are attached by way of a polymer unit or a bridging unit,
X=oxy, hydroxyl, alkoxy, carboxyl, silyl, alkyl-silyl, alkoxysilyl, siloxy, alkylsiloxy, alkoxy-siloxy, silylalkyl, alkoxysilylalkyl, alkylsilyl-alkyl, halogen, epoxy, ester, fluoroalkyl, isocyanate, blocked isocyanate, acrylate, methacrylate, nitrile, amino, phosphine group or substituents of the type R containing at least one such group of the type X,
the substituents of the type R being identical or different and the substituents of the type X being identical or different.

The present invention also provides for the use of the crosslinker of the invention in organic and/or inorganic matrix materials, and provides the matrix resulting therefrom and the process employed therefor.

The crosslinker of the invention has the advantage that the resulting materials, based on one or more organic matrix materials, have increased mechanical stability and mechanical strength, improved solvent resistance, improved barrier behavior, increased adhesion, higher temperature stability and/or abrasion resistance and scratch resistance on the surface. Moreover, the elasticity of inorganic materials can be raised by using chemical compounds comprising functionalized polyhedral oligomeric silicon-oxygen cluster units as crosslinking agent. In contrast to many conventional crosslinkers, the characteristics of the crosslinker of the invention can be controlled by way of the substituents of these polyhedral oligomeric silicon-oxygen cluster units and thus it is also possible to influence the properties of the resultant matrix. The crosslinker of the invention is able to react with itself and so form an independent network in the matrix, this network being composed of the resultant structural units of the crosslinker of the invention, or else the crosslinker of the invention, with its functional groups, is able to react with the functional groups of the matrix material and so bring about crosslinking of the matrix material. For the purposes of the present invention, the crosslinkers of the invention may also be used as curing agents.

A feature of the crosslinker of the invention for crosslinking matrix materials is that the crosslinker comprises functionalized polyhedral oligomeric silicon-oxygen cluster units of the formula
[(RₐX_{b}SiO_{1.5})ₘ(R_{c}X_{d}SiO)ₙ(RₑX_{f}Si₂O_{2.5})ₒ(R_{g}XₕSi₂O₂)ₚ]
with a,b,c=0-1; d=1-2; e,f,g=0-3; h=1-4; m+n+o+p≧4; a+b=1, c+d=2; e+f=3 and g+h=4;
R=hydrogen atom, alkyl, cycloalkyl, alkenyl, cyclo-alkenyl, alkynyl, cycloalkynyl, aryl, heteroaryl group or polymer unit, which are in each case substituted or unsubstituted or further functionalized polyhedral oligomeric silicon-oxygen cluster units, which are attached by way of a polymer unit or a bridging unit,
X=oxy, hydroxyl, alkoxy, carboxyl, silyl, alkyl-silyl, alkoxysilyl, siloxy, alkylsiloxy, alkoxy-siloxy, silylalkyl, alkoxysilylalkyl, alkylsilyl-alkyl, halogen, epoxy, ester, fluoroalkyl, isocyanate, blocked isocyanate, acrylate, methacrylate, nitrile, amino, phosphine group or substituents of the type R containing at least one such group of the type X,
the substituents of the type R being identical or different and the substituents of the type X being identical or different.

The use of crosslinkers of the invention comprising functionalized polyhedral oligomeric silicon-oxygen cluster units in organic matrix materials results in an increase not only in the mechanical stability and strength of the resultant materials but also in the thermal stability. Moreover, the elasticity of inorganic materials can be raised through the use of chemical compounds comprising functionalized polyhedral oligomeric silicon-oxygen cluster units as a crosslinking agent. In contrast to many conventional crosslinkers, the characteristics of the crosslinker of the invention can be controlled by way of the substituents of the functionalized polyhedral oligomeric silicon-oxygen cluster units and so the properties of the resultant material can also be influenced. Accordingly, it is possible to predetermine the physical and chemical properties of the crosslinker of the invention. The polarity of the crosslinker of the invention can be adjusted by way of the substituents of the type R and X on the polyhedral oligomeric silicon-oxygen cluster units. By way of the different structure and polarity of these substituents it is possible to control whether the polyhedral oligomeric silicon-oxygen cluster units are more inorganic or more organic in nature. Depending on structure, the crosslinkers of the invention may be of high thermal stability. As a result of the cage structure of the polyhedral oligomeric silicon-oxygen cluster units only a few functional groups are necessary for attachment of the crosslinker molecules, since with one functionalized group it is possible to attach an entire “cage”.

Preference is given to crosslinkers whose functionalized polyhedral oligomeric silicon-oxygen cluster unit is based on the structure 3 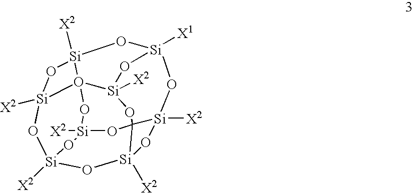
with X¹=substituent of type X or of type —O—SiX₃, X²=substituent of type X, —O—SiX₃, R, —O—SiX₂R, —O—SiXR₂ or —O—SiR₃,
R=hydrogen atom, alkyl, cycloalkyl, alkenyl, cycloalkenyl, alkynyl, cycloalkynyl, aryl, heteroaryl group or polymer unit, which are in each case substituted or unsubstituted or further functionalized polyhedral oligomeric silicon-oxygen cluster units, which are attached by way of a polymer unit or a bridging unit,
X=oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halogen, epoxy, ester, fluoroalkyl, isocyanate, blocked isocyanate, acrylate, methacrylate, nitrile, amino, phosphine group or substituents of the type R containing at least one such group of the type X,

The substituents of type X of the functionalized polyhedral oligomeric silicon-oxygen cluster units contain preferably isocyanate radicals, blocked isocyanate radicals, amino, acrylate, methacrylate, alkoxysilyl, alkoxysilylalkyl, hydroxyl and/or epoxy radicals. The polyhedral oligomeric silicon-oxygen cluster units of the crosslinker of the invention are functionalized by way of the substituents of type X.

For certain fields of application, such as in the case of coating materials, for example, it is possible to use crosslinkers having blocked or capped isocyanate groups. In the case of the crosslinker of the invention, this functionality can be controlled through the choice of the substituents of type X. For the field of use of coating materials it is possible with preference to use crosslinkers containing polyhedral oligomeric silicon-oxygen cluster units with blocked or capped isocyanate groups as substituents of type X. These crosslinkers of the invention can be prepared, for example, by way of a ring formation, in which two isocyanate molecules form a uretdione or three isocyanate molecules form an isocyanurate, or by a blocking procedure, with caprolactam, phenols or malonic acid, for example.

In one particular embodiment of the crosslinker of the invention at least two of the substituents are of the type X; in one particularly preferred embodiment of the crosslinker at least two of the substituents of the type X are identical.

On the basis of their molecular character, the crosslinkers of the invention possess a uniform and defined molecular weight. In one particular embodiment of the crosslinker of the invention it has a molecular weight of preferably at least 400 g/mol, more preferably from 700 to 3000 g/mol, and with particular preference from 800 to 1500 g/mol.

The molecular size of the crosslinker of the invention can be increased by joining two or more functionalized polyhedral oligomeric silicon-oxygen cluster units by means of condensation: for example, via a spacer and/or the functional groups of the substituent of type X. Additionally, an enlargement of the crosslinker of the invention can be achieved by means of homopolymerization or copolymerization. Grafting is also possible, i.e., the attachment of the crosslinker of the invention to a larger molecule or polymer. For example, the polyhedral oligomeric silicon-oxygen cluster units can be joined to polymers by hydrosilylation. In this way it is possible to prepare molecules of more than 5 nm in size (maximum extent of the crosslinker of the invention). It may also be advantageous if the crosslinker of the invention has a molecular size of from 0.1 to 500 nm, preferably from 0.5 to 50 nm, and with very particular preference from 1 to 25 nm. In order to increase the molecular size of the crosslinker of the invention it is possible to use dendrimer structures or hyperbranched structures.

In another embodiment the crosslinker of the invention may comprise further compounds having crosslinking properties, this combination of different crosslinkers including at least one crosslinker which comprises functionalized polyhedral oligomeric silicon-oxygen cluster units.

The polyhedral oligomeric silicon-oxygen cluster units relate in particular to the class of the spherosilicates of the formula
[(RₑX_{f}Si₂O_{2.5})ₒ(R_{g}XₕSi₂O₂)ₚ] with e,f,g=0-3; h=1-4; o+p≧4; e+f=3 and g+h=4,
but preferably to the class of the silasesquioxanes of the formula
[(RₐX_{b}SiO_{1.5})ₘ(R_{c}X_{d}SiO)ₙ] with a,b,c=0-1; d=1-2; m+n≧4; a+b=1; c+d=2.

Particularly preferred crosslinkers are those based on the functionalized oligomeric silasesquioxane unit of structure 4, 5 or 6 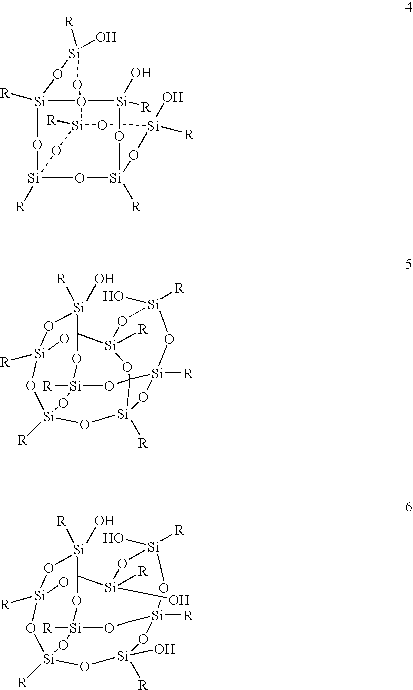
with R=hydrogen atom, alkyl, cycloalkyl, alkenyl, cycloalkenyl, alkynyl, cycloalkynyl, aryl, heteroaryl group or polymer unit, which are in each case substituted or unsubstituted or further functionalized oligomeric silasesquioxane units which are attached by way of a polymer unit or a bridging unit, the silasesquioxane unit being functionalized by way of at least two hydroxyl groups.

The substituents of type R of the silasesquioxane units may all be identical, producing what is termed a functionalized homoleptic structure
[(RSiO_{1.5})ₘ(RXSiO)ₙ] 7
with m+n=z and z≧4, z corresponding to the number of silicon atoms in the framework structure of the polyhedral oligomeric silicon-oxygen cluster unit, and
R=hydrogen atom, alkyl, cycloalkyl, alkenyl, cycloalkenyl, alkynyl, cyclo-alkynyl, aryl, heteroaryl group or polymer unit, which are in each case substituted or unsubstituted or further functionalized polyhedral oligomeric silicon-oxygen cluster units, which are attached by way of a polymer unit or a bridging unit,
X=oxy, hydroxyl, alkoxy, carboxyl, silyl, alkylsilyl, alkoxysilyl, siloxy, alkyl-siloxy, alkoxysiloxy, silylalkyl, alkoxysilylalkyl, alkylsilylalkyl, halogen, epoxy, ester, fluoroalkyl, isocyanate, blocked isocyanate, acrylate, methacrylate, nitrile, amino, phosphine group or substituents of the type R containing at least one such group of the type X, the substituents of the type R being identical or different and the substituents of the type X being identical or different.

In another embodiment of the crosslinker the silasesquioxane unit has a functionalized heteroleptic structure, in which at least two of the substituents of type R according to structure 7 are different.

The crosslinkers of the invention which comprise functionalized oligomeric silasesquioxane units can be obtained by reacting silasesquioxanes having free hydroxyl groups with monomeric functionalized silanes of structure Y₃Si—X^{I}, Y₂SiX^{I}X^{II}, and YSiX^{I}X^{II}X^{III}, the substituent Y being a leaving group selected from alkoxy, carboxyl, halogen, silyloxy or amino group, the substituents X^{I}, X^{II}, and X^{III} being of the type X and being identical or different, where X=oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halogen, epoxy, ester, fluoroalkyl, isocyanate, blocked isocyanate, acrylate, methacrylate, nitrile, amino, phosphine group or substituents of type R containing at least one such group of the type X, and R=hydrogen atom, alkyl, cycloalkyl, alkenyl, cycloalkenyl, alkynyl, cycloalkynyl, aryl, heteroaryl group or polymer unit, which are in each case substituted or unsubstituted or further functionalized oligomeric silasesquioxane units which are attached by way of a polymer unit or a bridging unit.

The general feature of a matrix of the invention is that it has been crosslinked by means of at least one crosslinker of the invention. The matrix has preferably from 0.05 to 100% by weight, more preferably from 0.1 to 50% by weight, of the crosslinker of the invention, with particular preference from 1 to 30% by weight, and with very particular preference from 3 to 25% by weight of the crosslinker of the invention. Preference may also be given to a matrix crosslinked by means of a combination of different crosslinkers including at lest one crosslinker of the invention. Where a combination of crosslinkers is used the matrix material has an added amount of the crosslinker of the invention, based on the matrix material to be crosslinked, of preferably from 0.1 to 25% by weight, more preferably from 1 to 20% by weight, and with particular preference from 5 to 15% by weight. In the case of a combination of crosslinkers, the matrix material may include a prior art amount of conventional crosslinkers. By way of example, crosslinkers of the invention comprising oligomeric silasesquioxane units functionalized with isocyanate groups may be combined in any proportion with conventional isocyanate-based crosslinkers and used for the crosslinking of hydroxyl-containing polyesters. Conventional isocyanate-based crosslinkers that can be used include isophorone diisocyanate (IPDI), 2,4- and 2,6-tolylene diisocyanate (TDI), naphthylene 1,5-diisocyanate (NDI), diphenylmethane 4,4′-diisocyanate (MDI), triphenylmethane 4,4′,4″-triisocyanate and/or hexamethylene diisocyanate (HDI). In accordance with the invention it is, however, also possible for the matrix to comprise exclusively the crosslinker of the invention, which in that case combines the function of the matrix material and of the crosslinker.

The matrix may comprise organic and/or inorganic matrix materials. The inorganic matrix material of the matrix serves preferably to produce glasses, mineral building materials and/or inorganic sinter compositions. Alternatively, the matrix may comprise an elastomer, thermoplastic or thermoset. Particular preference is given to using an organic matrix material comprising a polymer selected from polyethylene, polypropylene, polyester, copolyester, polycarbonate, polyamide, copolyamide, polyurethane, polyacrylate, poly-methacrylate, polymethacrylate copolymer, polysiloxane, polysilane, polytetrafluoroethylene, phenolic resin, polyoxymethylene, epoxy resin, polyvinyl chloride, vinyl chloride copolymer, polystyrene, styrene copolymer, ABS polymer, alkyd resin, unsaturated polyester resin, nitrocellulose resin or rubber.

One particular embodiment of the matrix of the invention comprises an organic matrix selected from hydrocarbon resins, polyamide resins, alkyd resins, maleate resins, polyacrylates, urea resins, polyterpene resins, ketone-aldehyde resins, epoxy resins, phenolic resins, polyesters, and polyurethane systems, cellulose derivatives, resins based on rosin, shellac and dammar, and all derivatives derived from the aforementioned resins. Such a matrix is suitable with preference for the preparation of paint systems and printing ink systems, with particular preference also for the preparation of powder coating materials.

In one particular embodiment of the matrix the crosslinker of the invention forms preferably at least one, more preferably two, and with very particular preference more than two covalent bonds to the matrix material. For this purpose it is necessary for the reactive substituents of type X of the crosslinker of the invention and the reactive functional groups in the matrix material to be crosslinked to be matched to one another. For instance, both the matrix material and the crosslinker of the invention may comprise double bonds, hydroxyl, carboxyl, amino, isocyanate or epoxy groups. By radiation, temperature, addition of moisture or addition of initiator the reaction between the matrix material and the crosslinker of the invention is initiated, and so covalent bonds are formed. The radiation used for initiating the process of crosslinking may comprise electron beams, UV radiation or microwaves.

In the case of apolar matrix materials, which have no reactive functional groups for covalent attachment of the crosslinker of the invention to the matrix material, the crosslinker of the invention reacts preferably with itself and so forms an independent network in the matrix, said network being composed of the resulting structural units of the crosslinker of the invention. In this case as well the process of crosslinking can be initialized by means of moisture, electron beams, UV radiation or microwaves.

The crosslinker of the invention can be used for crosslinking an inorganic matrix for producing glasses, ceramics, concrete, mortar, plaster and/or mineral building materials. This crosslinker of the invention may likewise be used for preparing plastics, paints, inks, such as printing inks, for example, adhesives, sealants, casting compounds, filling compounds, spreading compounds, foams, and coatings, which can be used both with organic materials and with inorganic or metallic materials.

When the crosslinker of the invention with alkoxysilyl- or alkoxysilylalkyl-functionalized polyhedral oligomeric silicon-oxygen cluster units is introduced into mineral substances, such as into plasters, for example, the crosslinker of the invention preferably contains a group which is capable of adhesion to mineral substances, which is able to react, for example, with the hydroxyl groups of the mineral substance.

This particular embodiment of the crosslinker of the invention, with alkoxysilyl- or alkoxysilylalkyl-functionalized polyhedral oligomeric silicon-oxygen cluster units, can be used as a crosslinker of organic coatings on glasses. This crosslinker is able both to crosslink the coating and to react with the hydroxyl groups of the glass, thereby producing good adhesion of the coating to the glass. The crosslinker of the invention can also be used for coatings of ceramics.

For producing coatings for glasses, but also for the coating of plastics, crosslinkers of the invention can be used which comprise acrylate- or methacrylate-functionalized polyhedral oligomeric silicon-oxygen cluster units. The mixture used for the coating contains preferably from 0.05 to 100% by weight, more preferably from 5 to 95% by weight, and with particular preference from 10 to 60% by weight of the crosslinker of the invention. The remaining amount may be an organic solvent, in which the crosslinker of the invention may be dissolved or dispersed, a propellant gas or carrier gas and/or a suitable organic matrix material, which together, for example, with the crosslinker may form a multidimensional network, by polymerization, for example. Suitable propellant gases or carrier gases are preferably propane, butane, dimethyl ether, fluorinated hydrocarbons, nitrogen, dinitrogen monoxide, air and/or gaseous carbon dioxide. Solvents used can be aliphatics, cycloaliphatics, halogenated hydrocarbons, cyclic ethers or acyclic ethers, for example. The coating is applied either by spreading on, by spraying by means for example of “airless” apparatus or compressed air guns, which have a pressure of from 2 to 20 bar and a nozzle diameter of from 0.2 to 1.0 mm, or by spraying on using, for example, spray cans, which have a pressure of from 1.2 to 10 bar and a nozzle diameter of from 0.2 to 1.0 mm.

Crosslinkers of the invention comprising isocyanate-functionalized polyhedral oligomeric silicon-oxygen cluster units can be used, alone or in combination with conventional isocyanate-based crosslinkers, for crosslinking polyols and/or hydroxyl-containing polyesters. This produces coating materials, e.g., powder coating materials, but also casting, spreading, and filling compounds, and also adhesives, foams, and sealants.

The functionalization of the polyhedral oligomeric silicon-oxygen cluster units of the crosslinker of the invention with an epoxy group makes it possible, in conjunction with hydroxyl-containing or amino-containing polyesters, to produce innovative epoxy systems for coating materials, casting compounds, and adhesives.

From hydroxyl-containing polyesters it is possible, in combination with the crosslinkers of the invention functionalized with hydroxyl groups, to produce reactive hotmelts and hotmelt adhesives or adhesives having improved mechanical stability and strength, improved solvent resistance, and higher temperature stability. As Dynacoll 7000 [symbol] Degussa supplies hydroxyl-containing polyesters which are reacted at the premises of the adhesives manufacturer with diisocyanates, such as MDI or IPDI, for example, depending on the desired degree of crosslinking. The customer applies these systems as hotmelt adhesives: through absorption of atmospheric moisture some of the free isocyanate groups form an amine and react with the remaining isocyanate groups to form a substituted urea, with subsequent polymerization and crosslinking of the hotmelt adhesive taking place in this way (Huber, M\overline{u}ller, Adhesives Age, November 1987, 32). By adding hydroxyl-functionalized crosslinkers of the invention and additionally adding diisocyanate or recalculating the amount of diisocyanate (that is, taking account of hydroxyl groups additionally introduced into the matrix by hydroxyl-containing crosslinker when determining the amount of isocyanate overall) so as to maintain the desired 1:1 ratio of hydroxyl groups to isocyanate groups, it is possible to obtain bonds with massively improved mechanical stability, strength, solvent resistance, and temperature stability.

By attaching an epoxy group to a polyhedral oligomeric silicon-oxygen cluster unit of the crosslinker of the invention it is possible, in conjunction with hydroxyl-containing or amino-containing polyesters, on the one hand to produce innovative epoxy systems for coating materials, casting compounds, and adhesives; on the other hand, by way of the functionalization of a polyhedral oligomeric silicon-oxygen cluster unit of the crosslinker of the invention with an amino group, it is possible to cure the known systems comprising 1-chloro-2,3-epoxypropane and bisphenol A. A matrix of this kind is crosslinked in conventional manner with amines, such as isophoronediamine (IPDA), diethylene-triamine (DETA), triethylenetetramine (TETA) or tetra-ethylenepentamine (TEPA), for example. Here too it is possible to combine epoxy- or amino-functionalized crosslinkers of the invention with other crosslinkers and/or curing agents in any proportion.

One particular application of the crosslinkers of the invention may be for coatings of chips in the computer industry. The systems of the invention may have excellent insulator properties (low dielectric constant), so that no notable capacitance is able to build up between two conductor tracks. The term used by the skilled worker in this case is a low k value, a low electrical permittivity. The systems of the invention may accordingly have excellent credentials for use for computer chips. Preferably, in this case, the crosslinker of the invention also represents the organic matrix itself, so that there is no absolute need for an extraneous matrix.

The process of the invention for crosslinking matrix materials to form a solid matrix comprises using a crosslinker of the invention. The individual process steps can be conducted as for conventional processes of crosslinking. There is no need for any special process steps in order to obtain the desired matrix.

The examples which follow are intended to illustrate the invention without restricting the scope of its protection:

### EXAMPLES 1

### Preparation of the Silasesquioxanes

### Example 1.1

### Synthesis of (isobutyl)₈Si₈O₁₂ from (isobutyl)Si(OMe)₃

To a solution of 446 g (2.5 mol) of isobutyltrimethoxy-silane (isobutyl)Si(OMe)₃ in 4300 ml of acetone there is added with stirring a solution of 6.4 g (0.11 mol) of KOH in 200 ml of H₂O. The reaction mixture is subsequently stirred at 30° C. for 3 days. The precipitate formed is filtered off and dried under reduced pressure at 70° C. The product (isobutyl)₈Si₈O₁₂ is obtained in a yield of 262 g (96%).

### Example 1.2

### Synthesis of (isobutyl)₇Si₇O₉(OH)₃ from (isobutyl)₈SisO₁₂

### Example of the Synthesis of an Incompletely Condensed Silasesquioxane Having Three Free Hydroxyl Groups

At a temperature of 55° C. 55 g (63 mmol) of (isobutyl)₈Si₈O₁₂ are introduced into 500 ml of an acetone/methanol mixture (volume ratio 84:16) which contains 5.0 ml (278 mmol) of H₂O and 10.0 g (437 mmol) of LiOH. The reaction mixture is subsequently stirred at 55° C. for 18 h and then introduced into 500 ml of 1 N hydrochloric acid. After stirring for 5 minutes the solid obtained is filtered off and washed with 100 ml of CH₃OH. Drying in air gives 54.8 g (96%) of (isobutyl)₇Si₇O₉(OH)₃.

### Example 1.3

### Synthesis of (isobutyl)₇Si₇O₉(OSiMe₃)(OH)₂

### Example of the Synthesis of an Incompletely Condensed Silasesquioxane Having Two Free Hydroxyl Groups

This compound is prepared by reacting the trisilanol (isobutyl)₇Si₇O₉(OH)₃ (from Example 1.2) with the chlorosilane ClSi(Me)₃ using a base, such as triethylamine, with THF solvent at a temperature of 20° C. Stirring is carried out overnight.

### Example 1.4

### Synthesis of (isobutyl)₇Si₇O₉(OSiMe₃)[OSiMe₂(CH₂)₃NCO]₂ Starting from (isobutyl)₇Si₇O₉(OSiMe₃)(OH)₂

### Example of a Functionalized Silasesquioxane Having Two Isocyanate End Groups

To a solution of 10 g (11.6 mmol) of (isobutyl)₇Si₇O₉(OSiMe₃)(OH)₂ in 50 ml of THF containing 7 ml of triethylamine (Et₃N) there are added, at a temperature of 20° C., 4.29 g (25 mmol) of 3-isocyanato-propyldimethylchlorosilane. The mixture is stirred overnight. Thereafter the solvent is removed under reduced pressure. The product is isolated by extraction with 2×100 ml of hexane. The extract is stripped under reduced pressure to give a thick oil, which is then taken up in 20 ml of toluene and precipitated by adding 100 ml of acetonitrile. The yield of the product is 85%.

### Example 1.5

### Synthesis of (isobutyl)₇Si₇O₉[OSiMe₂(CH₂)₃NCO]₃ Starting from (isobutyl)₇Si₇O₉(OH)₃

### Example of a Functionalized Silasesquioxane Having Three Isocyanate End Groups

To a solution of 10 g (12.6 mmol) of (isobutyl)₇Si₇O₉(OH)₃ in 50 ml of THF containing 10 ml of triethylamine (Et₃N) there are added, at a temperature of 20° C., 6.87 g (40 mmol) of 3-isocyanato-propyldimethylchlorosilane. The mixture is stirred overnight. Thereafter the solvent is removed under reduced pressure. The product is isolated by extraction with 2×100 ml of hexane. The extract is stripped under reduced pressure to give a thick oil, which is then taken up in 20 ml of toluene and precipitated by adding 100 ml of acetonitrile. The yield of the product is 89%.

### Example 1.6

### Synthesis of (isobutyl)₇Si₇O₉(OSiMe₃)[OSiMe₂(CH₂)₃NH₂]₂ Starting from (isobutyl)₇Si₇O₉(OSiMe₃)(OSiMe₂H)₂ (from Hybrid Plastics)

### Example of a Functionalized Silasesquioxane Having Two Amino End Groups

To a solution of 4.0 g (4.1 mmol) of (isobutyl)₇Si₇O₉(OSiMe₃)(OSiMe₂H)₂ in 25 ml of toluene there are added, at a temperature of 20° C., 0.51 g (9.0 mmol) of allylamine and 50 mg of a platinum-divinyltetramethyl-disiloxane complex in xylene (from ABCR Gelest GmbH & Co KG). The mixture is stirred overnight. Thereafter the solvent is removed under reduced pressure. The product is precipitated by adding 150 ml of acetonitrile, filtered off, and washed with 2×20 ml of acetonitrile. The yield of the product is 71%.

### Example 1.7

### Synthesis of (isobutyl)₇Si₇O₉[OSiMe₂(CH₂)₃NH₂]₃ Starting from (isobutyl)₇Si₇O₉ [OSiMe₂H]₃ (=SH1307 from Hybrid Plastics)

### Example of a Functionalized Silasesquioxane Having Three Amino End Groups

To a solution of 3.96 g (4.1 mmol) of (isobutyl)₇Si₇O₉[OSiMe₂H]₃ in 25 ml of toluene there are added, at a temperature of 20° C., 0.80 g (14 mmol) of allylamine and 50 mg of a platinum-divinyltetramethyldisiloxane complex in xylene (from ABCR Gelest GmbH & Co KG). The mixture is stirred overnight. Thereafter the solvent is removed under reduced pressure. The product is precipitated by adding 150 ml of acetonitrile, filtered off, and washed with 2×20 ml of acetonitrile. The yield of the product is 66%.

### Example 1.8

### Synthesis of (isobutyl)₇Si₇O₉(OSiMe₃)[OSiMe₂(CH₂)₃OCOC(Me)=CH₂]₂ Starting from (isobutyl)₇Si₇O₉(OSiMe₃)(OH)₂

### Example of a Functionalized Silasesquioxane Having Two Methacrylate End Groups

To a solution of 10 g (11.6 mmol) of (isobutyl)₇Si₇O₉(OSiMe₃)(OH)₂ in 50 ml of THF containing 7 ml of triethylamine there are added, at a temperature of 20° C., 5.52 g (25 mmol) of 3-meth-acryloyloxypropyldimethylchlorosilane. The mixture is stirred overnight. Thereafter the solvent is removed under reduced pressure. The product is isolated by extraction with 2×100 ml of hexane. The extract is stripped under reduced pressure to give a thick oil, which is then taken up in 20 ml of toluene and precipitated by adding 100 ml of acetonitrile. The yield of the product is 85%.

### Example 1.9

### Synthesis of (isobutyl)₇Si₇O₉[OSiMe₂(CH₂)₃OCOC(Me)=CH₂]₃ Starting from (isobutyl)₇Si₇O₉(OH)₃

### Example of a Functionalized Silasesquioxane Having Three Methacrylate End Groups

To a solution of 10 g (12.6 mmol) of (isobutyl)₇Si₇O₉(OH)₃ in 50 ml of THF containing 10 ml of triethylamine there are added, at a temperature of 20° C., 8.83 g (40 mmol) of 3-meth-acryloyloxypropyldimethylchlorosilane. The mixture is stirred overnight. Thereafter the solvent is removed under reduced pressure. The product is isolated by extraction with 2×100 ml of hexane. The extract is stripped under reduced pressure to give a thick oil, which is then taken up in 20 ml of toluene and precipitated by adding 100 ml of acetonitrile. The yield of the product is 85%.

### Example 2

### Tests

### Example 2.1

### Testing as a Hotmelt Adhesive Coating

In a three-necked round-bottomed flask 1 mol of polyester corresponding to the composition of Table 2.1.1, having a hydroxyl number of 30, is melted at a temperature of 130° C. and degassed by applying reduced pressure for 30 minutes. Thereafter, at a temperature of 120° C., 2.2 mol of diisocyanate or triisocyanate are added with stirring and homogenized. Stirring is continued in the absence of moisture at 120° C. for the complete reaction of the components.

Setting Time

To measure the setting time, the hotmelt adhesive is applied thinly from the melt, which is at 120° C., to a 25×25 mm wooden block and immediately thereafter this block is joined or adhesively bonded with a second wooden block of the same base area. The setting time indicates how long the pieces of wood can still be displaced relative to one another by means of strong finger pressure. The lower the period of time, the more favorable the setting behavior of the hotmelt adhesive.

Bonding Tests

Inventive and noninventive polymer compositions according to Examples 2.1 are prepared and then applied at a temperature of 120° C. to a wooden test element. This wooden element is joined over an area of 4 cm² within 0.5 minute to a further wooden test element, with a simple overlap, and the wooden elements are pressed against one another with a weight of 2 kg for 5 minutes. The bonded specimen is then stored at 23° C. and 60% relative humidity for 14 days, after which a tensile test and a thermal stability test are conducted. The results are shown in Table 2.1.1.

TABLE 2.1.1
Composition of the hotmelt adhesives (1 mol) and their properties after reaction with 2.2 mol of
diisocyanates or triisocyanates

| | | Viscosity | | | | | Tensile shear |
|---|---|---|---|---|---|---|---|
| Composition | | at 130° C. | | | | Heat Stability | strength according |
| of the | | (Brookfield, | Non- | | Setting | according to | to DIN |
| polyester | Crosslinker | in Pa s) | inventive | Inventive | time(s) | 68 WPS (° C.) | 53 283 (N/mm²) |
| 50 mol % | MDI | 18 000 | x | | 15 | 191 | 2.2 |
| adipic acid + | Crosslinker from | 18 000 | | x | 5 | 245 | 3.5 |
| 50 mol % | Example 1.4 | | | | | | |
| hexanediol | 50 mol % MDI + 50 | 18 000 | | x | 9 | 207 | 2.9 |
| | mol % crosslinker | | | | | | |
| | from Example 1.4 | | | | | | |
| 25 mol % | MDI | 12 000 | x | | 10 | 185 | 2.3 |
| adipic acid + | Crosslinker from | 12 500 | | x | 4 | 261 | 3.6 |
| 25 mol % | Example 1.5 | | | | | | |
| dodecanedioic | 50 mol % MDI + 50 | 11 000 | | x | 8 | 212 | 3.0 |
| acid + 50 | mol % crosslinker | | | | | | |
| mol % | from Example 1.5 | | | | | | |
| hexanediol | | | | | | | |

It is evident that using the crosslinkers of the invention rather than conventional crosslinkers shortens the fitting time and allows marked improvements in the tensile shear strength and thermal stability.

### Example 2.2

### Testing in Casting Resin Systems

As casting resins it is possible to use epoxy resin systems, which are normally based on bisphenol A diglycidyl ether and amine curing agents, such as isophoronediamine (IPDA), for example. As a general rule, in order to obtain optimum properties, it is important to attain as high as possible a degree of curing. For that reason it is advantageous to use two kinds of reaction accelerants, namely those for controlling the processing time (pot life) and those for influencing the crosslinking density. A further aim is to lower the maximum temperature during curing, since this goes hand in hand with reducing the shrinkage. DE 42 11 454 describes a process for the preparation and the use of isophoronediamine which is present 59% in trans form and 41% in cis form. Through the use of products from Examples 1.6 and 1.7 it is possible to use commercial-grade IPDA having a trans content of 24% and a cis content of 76%.

Preparation of the Casting Resin System

In each case an epoxy resin based on bisphenol A diglycidyl ether (epoxide number 5.30 equivalents/kg, viscosity at 25° C. 10 500 mpas) and commercial-grade IPDA. For better through-curing, benzyl alcohol, in which the IPDA and the salicyl alcohol likewise used are initially dissolved, is added. The results are shown in Table 2.2.1

TABLE 2.2.1
Composition of the casting compounds and their properties

| | | | | | König |
|---|---|---|---|---|---|
| | | | Service | Temperature | pendulum |
| | Non- | | life (min) | rise ° C. | hardness (s) |
| Composition | inventive | Inventive | 10 g/23° C. | (200 g batch) | DIN 53157* |
| 69% by weight epoxy resin | x | | 74 | 190 | 208 |
| + 15% by weight IPDA (76% | | | | | |
| cis, 24% trans) + 14% by | | | | | |
| weight benzyl alcohol + 2% | | | | | |
| by weight salicyl alcohol | | | | | |
| 68% by weight epoxy resin | | x | 87 | 161 | 217 |
| + 15% by weight IPDA (76% | | | | | |
| cis, 24% trans) + 14% by | | | | | |
| weight benzyl alcohol + 2% | | | | | |
| by weight salicyl alcohol + | | | | | |
| 1% by weight Example 1.6 | | | | | |
| 68% by weight epoxy resin | | x | 83 | 166 | 215 |
| + 15% by weight IPDA (76% | | | | | |
| cis, 24% trans) + 14% by | | | | | |
| weight benzyl alcohol + 2% | | | | | |
| by weight salicyl alcohol + | | | | | |
| 1% by weight Example 1.7 | | | | | |

*This coatings test was carried out on special metal panels - Chemetall No. 129611 with Bonder rust protection 26/NL 60 - at a dry film thickness of 45 +/−5 μm.

It is evident that the compositions of the invention as compared with conventional compositions have a longer service life, and a lower maximum temperature with at least equally good or improved coating performance properties.

### Example 2.3

### Testing in an Inorganic Matrix (Mortar)

12.5 parts by weight of Portland cement, 12.5 parts by weight of lime and 75.0 parts by weight of weather sand (all components from the builder's merchant) are mixed with water to form a high-viscosity mortar. 0.06 part by weight of each of the products from Examples 1.2, 1.7 and 1.8 are incorporated homogeneously in various experiments with the compositions of the invention. A rectangular mold of edge length 150×20×5 mm is subsequently filled with this mortar at room temperature and after one day this mixture is removed from the mold. The mortar is then left to dry at room temperature for three days more. After drying and demolding the test specimens are dropped horizontally from a height of 1.50 m onto a concrete floor. The fracture behavior is assessed (Table 2.3.1). Following visual assessment, the scores 1 (very good) to 5 (very poor) were awarded.

TABLE 2.3.1
Composition of the inorganic matrix and its properties

| Composition (parts | | | Fracture |
|---|---|---|---|
| by weight) | Noninventive | Inventive | behavior |
| 100 pure mortar | x | | 5 |
| 100 pure mortar + | | x | 2 |
| 0.06 Example 1.2 | | | |
| 100 pure mortar + | | x | 3 |
| 0.06 Example 1.7 | | | |
| 100 pure mortar + | | x | 3 |
| 0.06 Example 1.8 | | | |

It is evident that the compositions have a higher elasticity and improved fracture behavior as compared with conventional compositions.

The chemicals used in the examples were obtained from the following suppliers:
ABCR Gelest GmbH & Co KG (Postfach 210135; Hansastr. 29c; D-76189 Karlsruhe)
Aldrich (P.O. Box 355; Milwaukee; Wis. 53201; USA)
Sigma-Aldrich Chemie GmbH (Postfach; D-80239 Deisenhofen)
Hybrid Plastics (18237 Mt. Baldy Circle; Fountain Valley, Calif. 92708-6117, USA)

1-28. (canceled)

29. A matrix which has been crosslinked by means of at least one crosslinker which comprises functionalized polyhedral oligomeric silicon-oxygen cluster units of the formula
[(RₐX_{b}SiO_{1.5})ₘ(R_{c}X_{d}SiO)ₙ(R_{g}XₕSi₂O₂)ₚ]
with a,b,c=0-1; d=1-2; e,f,g=0-3; h=1-4; m+n+o+p≧4; a+b=1, c+d=2; e+f=3 and g+h=4;
R=hydrogen atom, alkyl, cycloalkyl, alkenyl, cyclo-alkenyl, alkynyl, cycloalkynyl, aryl, heteroaryl group or polymer unit, which are in each case substituted or unsubstituted or further functionalized polyhedral oligomeric silicon-oxygen cluster units, which are attached by way of a polymer unit or a bridging unit,
X=oxy, hydroxyl, alkoxy, carboxyl, silyl, alkyl-silyl, alkoxysilyl, siloxy, alkylsiloxy, alkoxy-siloxy, silylalkyl, alkoxysilylalkyl, alkylsilyl alkyl, halogen, epoxy, ester, fluoroalkyl, isocyanate, blocked isocyanate, acrylate, methacrylate, nitrile, amino, phosphine group or substituents of the type R comprising at least one such group of the type X,
the substituents of the type R being identical or different and the substituents of the type X being identical or different and at least two of the substituents being of type X.

30. The matrix as claimed in claim 29, wherein the crosslinker comprises functionalized polyhedral oligomeric silicon-oxygen cluster units, at least one of the substituents of type X comprising an isocyanate, blocked isocyanate, amino, acrylate, methacrylate, alkoxysilyl, alkoxysilylalkyl, hydroxyl or epoxy group.

31. The matrix as claimed in claim 29, wherein the crosslinker comprises functionalized polyhedral oligomeric silicon-oxygen cluster units, at least two of the substituents of type X are identical.

32. The matrix as claimed in claim 29, which has been crosslinked by means of a combination of different crosslinkers.

33. The matrix as claimed in claim 29, which comprises an organic and/or inorganic matrix material.

34. The matrix as claimed in claim 29, which comprises as inorganic matrix material glasses, mineral building materials and/or inorganic sinter compositions.

35. The matrix as claimed in claim 29, which comprises as organic matrix material an elastomer or a thermoplastic or thermoset.

36. The matrix as claimed in claim 35, wherein the organic matrix material is a plastic selected from the group consisting of polyethylene, polypropylene, polyester, copolyester, polycarbonate, polyamide, copolyamide, polyurethane, polyacrylate, polymethacrylate, polymethacrylate copolymer, polysiloxane, polysilane, polytetrafluoro-ethylene, phenolic resin, polyoxymethylene, epoxy resin, polyvinyl chloride, vinyl chloride copolymer, polystyrene, styrene copolymer, ABS polymer, alkyd resin, unsaturated polyester resin, nitrocellulose resin, rubber and mixtures thereof.

37. The matrix as claimed in claim 29, wherein the silasesquioxane unit of the crosslinker forms at least one covalent bond to the matrix material.

38. The matrix as claimed in claim 29, wherein the matrix material comprises from 0.1 to 50% by weight of the crosslinker.

39. A method of crosslinking matrix materials to form a sold matrix, which comprises using a crosslinker which comprises functionalized polyhedral oligomeric silicon-oxygen cluster units of the formula
[(RₐX_{b}SiO_{1.5})ₘ(R_{c}X_{d}SiO)ₙ(RₑX_{f}Si₂O_{2.5})ₒ(R_{g}XₕSi₂O₂)ₚ]
with a,b,c=0-1; d=1-2; e,f,g=0-3; h=1-4; m+n+o+p≧4a+b=1, c+d=2; e+f=3 and g+h=4;
R=hydrogen atom, alkyl, cycloalkyl, alkenyl, cyclo-alkenyl, alkynyl, cycloalkynyl, aryl, heteroaryl group or polymer unit, which are in each case substituted or unsubstituted or further functionalized polyhedral oligomeric silicon-oxygen cluster units, which are attached by way of a polymer unit or a bridging unit,
X=oxy, hydroxyl, alkoxy, carboxyl, silyl, alkyl-silyl, alkoxysilyl, siloxy, alkylsiloxy, alkoxy-siloxy, silylalkyl, alkoxysilylalkyl, alkylsilyl alkyl, halogen, epoxy, ester, fluoroalkyl, isocyanate, blocked isocyanate, acrylate, methacrylate, nitrile, amino, phosphine group or substituents of the type R comprising at least one such group of the type X,
the substituents of the type R being identical or different and the substituents of the type X being identical or different and at least two of the substituents being of type X.

40. The method as claimed in claim 39, wherein the crosslinker comprises functionalized polyhedral oligomeric silicon-oxygen cluster units, at least one of the substituents of type X comprising an isocyanate, blocked isocyanate, amino, acrylate, methacrylate, alkoxysilyl, alkoxysilylalkyl, hydroxyl or epoxy group.

41. The method as claimed in claim 39, wherein the crosslinker comprises functionalized polyhedral oligomeric silicon-oxygen cluster units, at least two of the substituents of type X are identical.
